(19) United States
(12) Patent Application Publication
(10) Pub. No.: US 2016/0008992 A1
(43) Pub. Date: Jan. 14, 2016

(54) Scrapper knife/scrapper knife adaptor

(71) Applicant: RICKY D. RUSSELL, LAMBERTVILLE, MI (US)

(72) Inventor: RICKY D. RUSSELL, LAMBERTVILLE, MI (US)

(21) Appl. No.: 14/542,567

(22) Filed: Nov. 15, 2014

Related U.S. Application Data
(60) Provisional application No. 61/903,929, filed on Nov. 13, 2013.

(51) Int. Cl. B26B 11/00; B44D 3/16

(52) U.S. Cl. CPC B26B 11/00; B44D 3/162

(57) ABSTRACT

The scrapper knife has multi-purpose abilities utilized as a cutting tool used in food preparation. There are two edges or blades on the scrapper knife. The sharp blade and the dull or scrapper blade. On the sharp or cutting blade employs differential sharpening along the length of the blade. The fine tip,is used for precision work such as mincing, and might be ground with a very sharp, acute cutting bevel, the midsection or belly of the blade receives a moderately sharp edge for general cutting, chopping and slicing, while the heavy heel or back of the cutting edge is given a strong thick edge for such heavy-duty task like disjointing beef.

The dull edge or blade of the scrapper knife can be utilized to scoop up and transport food prepared with the sharp blade of the knife. Holding the scrapper knife with the right hand for example, and with a slight manipulation of of the hand to position the dull blade on the cutting surface to scoop up the processed food product with the left hand on to dull blade of the scrapper knife After loading the scrapper knife with processed food product, commencement of transporting the food product can be conducted.

Scrapper knife adapter is dull blade that adapts or slips upon an existing food processing knife, for example a chefs knife After attaching the scrapper knife adapter to a chefs knife and processing food product with the sharp blade, and then by a slight manipulation of the right hand for example to position the scrapper knife adapter blade to the cutting surface to scoop the up the processed food product with the left hand on to the scrapper knife adapter to allow transport of food products to there desired location.

### PREAMBLE

I RICKY D. RUSSELL, have invented a scrapper knife and scrapper knife adapter for use in kitchens and restaurants. These knifes will help save time,money and the cutting edge as well as transport food product during food processing.

### DESCRIPTION OF THE DRAWINGS

The application includes the following drawings of the new and useful nonprovisional utility invention.

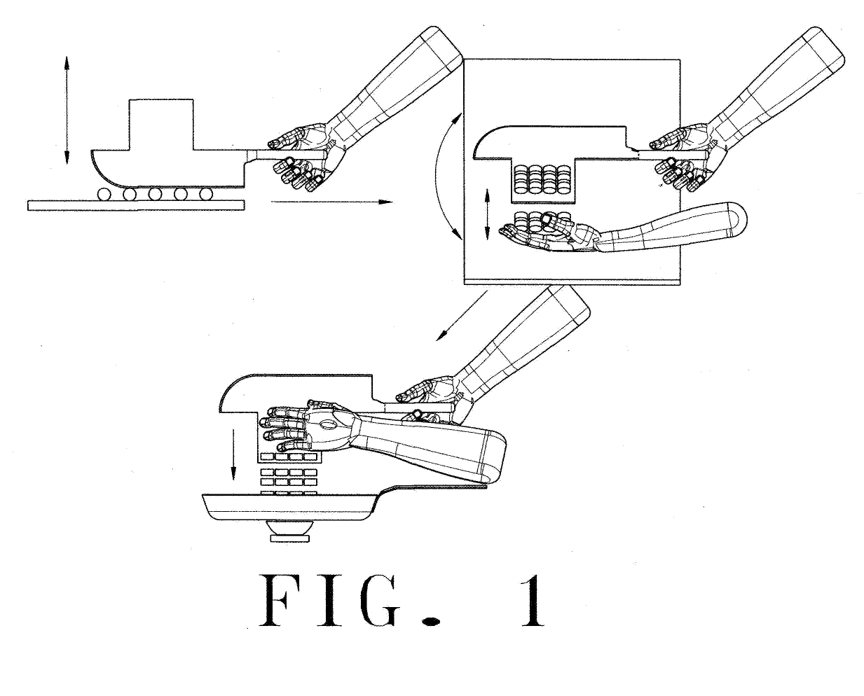

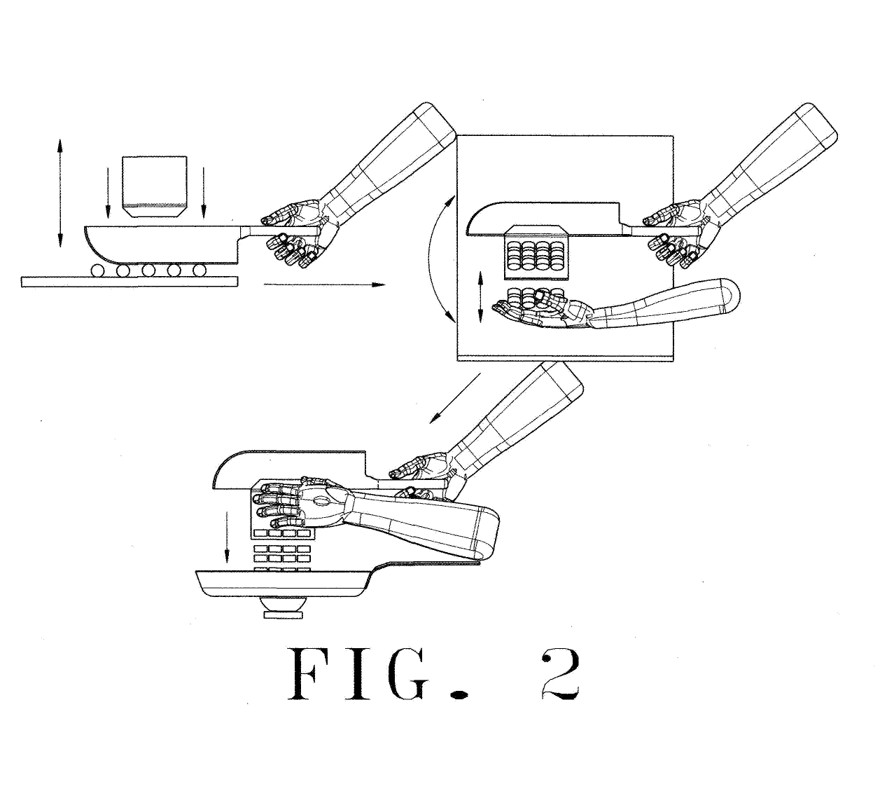

Drawing FIG. 1; the scrapper knife Drawing FIG. 2.; the scrapper knife adapter.

### SPECIFICATION

The scrapper knife is a one piece combination knife, one edge is a dull transporting knife and the other edge is a sharp cutting knife. This knife will be made of food grade knife making material.

The scrapper knife adapter with a dull straight transporting edge will accommodate the dull edge of a sharp cutting food processing knife This knife will be made of food grade knife making material.

A scrapper knife or scrapper knife adapter is a fantastic food processing and transporting knife for use in kitchens and restaurants, it not only will save time but will save the sharp cutting edge. You simply cut the food with the sharp edge and transport the food with the dull edge of the knife

The inspiration for the scrapper knife and scrapper knife adapter inventions came to me after watching cooking programs on PBS TV. The chefs use there food processing chefs knife to scoop up the processed food, also after processing the food they would set down the knife and grab an other knife to scoop up the processed food. The scrapper knife plus the scrapper knife adapter saves time and the sharp edge of the knife plus transports food products.

1. I Ricky D. Russell , claim the new and useful utility invention for the scrapper knife shown in drawing FIG. 1.

2. I Ricky D. Russell, claim the new and useful utility invention for the scrapper knife adapter shown in drawing FIG. 2.
